(19) United States
(12) Patent Application Publication
(10) Pub. No.: US 2023/0031691 A1
(43) Pub. Date: Feb. 2, 2023

(54) TRAINING MACHINE LEARNING MODELS

(71) Applicant: Capital One Services, LLC, McLean, VA (US)

(72) Inventors: Christian CARROLL, McLean, VA (US); Rachel ATMADJA, McLean, VA (US); Osinaka DESMOND, McLean, VA (US); Sze WONG, McLean, VA (US)

(73) Assignee: Capital One Services, LLC, McLean, VA (US)

(21) Appl. No.: 17/388,076

(22) Filed: Jul. 29, 2021

(51) Int. Cl. G06N 3/08; G06N 3/04

(52) U.S. Cl. CPC G06N 3/08; G06N 3/0454

(57) ABSTRACT

Methods and systems are disclosed herein for weighting training data for training a machine learning model. A computing system may use performance metrics to weight some training data over other training data. Weighting training data may increase the ability of a machine learning model to train faster and/or train to generate improved output. A portion of the training data may be weighted according to how well a machine learning model performs after being trained on the portion of training data. The computing system may train machine learning models using different data to train each machine learning model. The computing system may compare one or more performance metrics of each machine learning model and assign a weight to each corresponding dataset based on the comparison. The computing system may use the weighted dataset to train a machine learning model.

### BACKGROUND

In the last few years machine learning has become a de facto standard in building software in many industries. Machine learning models often require data to be trained, otherwise prediction accuracy of a machine learning model may be compromised. Thus, training data is a vital component of building machine learning models. However, it can be difficult to determine which data to use to train a machine learning model. For example, some data may be less effective than other data for training machine learning models. In addition, training a machine learning model using all of the available data may take too much time and/or computing resources. Although some data may be more effective for training a machine learning model (e.g., to perform with better accuracy, train faster, etc.), it can be difficult to determine how to use the data efficiently.

### SUMMARY

To address these and other issues, a computing system may use performance metrics to weigh some training data over other training data. Weighting training data may increase the ability of a machine learning model to train faster and/or train to generate improved output. A portion of the training data may be weighted according to how well a machine learning model performs after being trained on the portion of training data. Thus, different machine learning models may be trained using different data for each model. The computing system may determine one or more performance metrics for each machine learning model (e.g., precision, recall, accuracy, etc.). For example, a first machine learning model may be trained on data from a first time period (e.g., a decision tree may be trained on data received during January) and a second machine learning model may be trained on data from a second period (e.g., a second decision tree may be trained on data received during February). When each model has been trained, the computing system may input test data into each trained machine learning model to determine how well each machine learning model performs. The computing system may obtain one or more performance metrics (e.g., precision, recall, accuracy, etc.) from the trained machine learning models using the test data. For example, the computing system may input test data received after the first and second time periods (e.g., data receiving during March) into the first and second machine learning models and determine the accuracy of the models. The performance of each model may give an indication into how effective the training data used for each model was. This may enable the computing system to determine whether to use a particular training dataset and/or how much weight to give each training dataset when using it to train new machine learning models. The computing system may compare one or more performance metrics (e.g., precision, recall, log loss, and/or accuracy, etc.) of each machine learning model and assign a weight to each corresponding dataset based on the comparison. For example, if the first machine learning model performs better than the second machine learning model, the computing system may give the first dataset a higher weight than the second dataset. The computing system may train a new machine learning model using the weighted datasets. Using weighted datasets may increase the efficiency of the new models because it may be able to train machine learning models using less data and/or less computing resources. Additionally or alternatively, using weighted datasets may enable the computing system to train machine learning models to obtain better results (e.g., improved precision, recall, accuracy, etc.). Using weighted datasets may also lead to increased memory efficiency, for example, because less data will need to be stored for the machine learning models to train.

The computing system may train machine learning models (e.g., groups of machine learning models) using a different training dataset for each machine learning model (or a different training dataset for each group of machine learning model). Each training dataset may correspond to a different time period. For example, a first group of machine learning models may be trained using data corresponding to Quarter 1 of a given year (e.g., January-March) or a portion of Quarter 1 of a given year (e.g., January), a second group of machine learning models may be trained using data corresponding to Quarter 2 of that year (e.g., April-June) or a portion of Quarter 2 of that year (e.g., one machine learning model may be trained on data from April, another machine learning model may be trained on data from May), etc. The computing system may input one or more testing datasets into each machine learning model to obtain performance metrics for each machine learning model (e.g., accuracy, precision, recall, log loss, F1 score, root mean squared error, etc.). The testing dataset may correspond to a time period that is subsequent to the time periods used to train the machine learning models. For example, if the groups of machine learning models were each trained using data from different quarters of the year 2012, the testing dataset may correspond to data from the year 2013.

The computing system may select a subset of the machine learning models based on the determined performance metrics. Each selected machine learning model may correspond to a different time period and/or training dataset. For example, the computing system may select a first machine learning model from the first group of machine learning models to add to the subset (e.g., the computing system may select the machine learning model that had the best performance (e.g., highest accuracy) in the first group), a second machine learning model from the second group of machine learning models to add to the subset (e.g., the machine learning model that had the best performance (e.g., highest accuracy) in the second group), and so on. For example, each time period may correspond to one month, week, day, or another suitable tie period and the computing system may select the best performing machine learning model for that period.

The computing system may determine, based on a comparison of performance metrics corresponding to each machine learning model in the subset of machine learning models, a weight for each machine learning model of the subset of machine learning models. For example, the computing system may compare each of the best performing machine learning models (e.g., the computing system may compare one or more performance metrics of each of the best performing machine learning models) and assign each of the best performing machine learning models a weight. The computing system may weigh each of the training datasets based on the associated machine learning model's weight. For example, the weight assigned to the machine learning model selected from the first group of machine learning models may be applied to the dataset used to train the first group of machine learning models (e.g., the data from Quarter 1). The computing system may generate a weighted dataset by combining each of the weighted training datasets. The weighted dataset may be used to train a machine learning model. Alternatively, the datasets may not be combined and model training may be performed using each dataset with a corresponding weight.

Various other aspects, features, and advantages of the disclosure will be apparent through the detailed description of the disclosure and the drawings attached hereto. It is also to be understood that both the foregoing general description and the following detailed description are examples and not restrictive of the scope of the disclosure. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification “a portion,” refers to a part of, or the entirety of (i.e., the entire portion), a given item (e g., data) unless the context clearly dictates otherwise.

### BRIEF DESCRIPTION OF THE DRAWINGS

FIG. 1 shows an example computing system for training machine learning models, in accordance with some embodiments.

FIG. 2 shows example components that may be used to weight training data for a machine learning model, in accordance with some embodiments.

FIG. 3 shows example features that may be used in training data by a machine learning model to determine whether an action will be completed on time, in accordance with some embodiments.

FIG. 4 shows an example machine learning model, in accordance with some embodiments.

FIG. 5 shows an example computing system that may be used in accordance with some embodiments.

FIG. 6 shows an example flowchart of the actions involved in determining weights for data to use in training machine learning models, in accordance with some embodiments.

### DETAILED DESCRIPTION

In the following description, for the purposes of explanation, numerous specific details are set forth in order to provide a thorough understanding of the disclosure. It will be appreciated, however, by those having skill in the art, that the disclosure may be practiced without these specific details or with an equivalent arrangement. In other cases, well-known structures and devices are shown in block diagram form to avoid unnecessarily obscuring the disclosure.

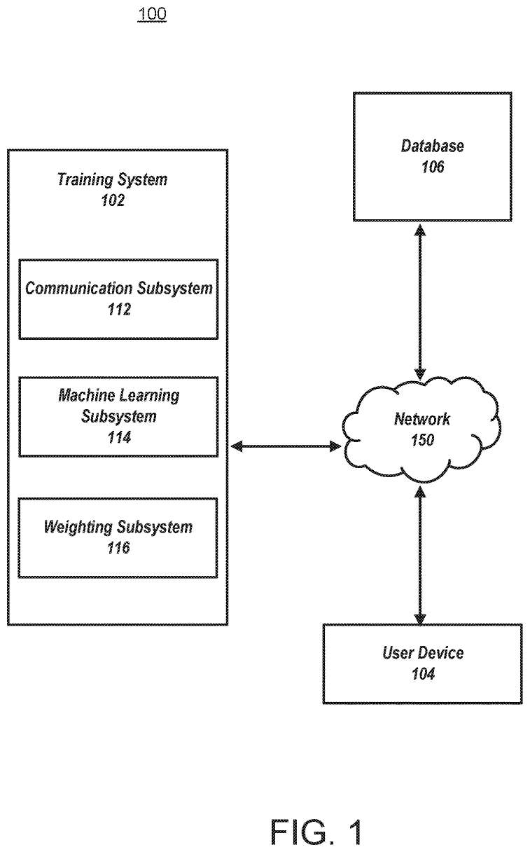

FIG. 1 shows an example computing system 100 for weighing training data to improve the performance/training of a new machine learning model and/or to provide additional training to an existing machine learning model. A computing system may use performance metrics to weigh some training data over other training data. Weighing training data may increase the ability of a machine learning model to train faster and/or train to generate improved output. The computing system may train machine learning models using different data to train each machine learning model. For example, the computing system may train machine learning models to predict whether an action (e.g., making a payment on an account, submitting a report, send a message, complete a work assignment, signing a document, or any other type of task) will be completed on time. A first model may be trained using data from a first three-month period, a second model may be trained using data from a second three-month period, and a third model may be trained using data from a third three-month period. The computing system may determine one or more performance metrics for each machine learning model (e.g., accuracy). The computing system may input test data into each trained machine learning model to determine how well each machine learning model performs. The computing system may obtain one or more performance metrics (e.g., precision, recall, accuracy, etc.) from the trained machine learning models using the test data. For example, the computing system may input test data received after the first, second, and third three-month periods into each machine learning model and determine the accuracy of the models. The performance of each model may give an indication into how effective the training data used for each model was. This may enable the computing system to determine whether to use a particular training dataset and/or how much weight to give each training dataset when using it to train a machine learning model. The computing system may compare one or more performance metrics (e.g. precision, recall, log loss, and/or accuracy, etc.) of each machine learning model and assign a weight to each corresponding dataset based on the comparison. For example, if the first machine learning model performs better than the second machine learning model, the computing system may give the first dataset a higher weight than the second dataset. The computing system may train a machine learning model using the weighted datasets. Using the weighted dataset may increase the efficiency of the computing system because it may be able to train machine learning models using less data and/or less computing resources. Additionally or alternatively, using the weighted dataset may enable the computing system to train machine learning models to obtain better results (e.g., improved precision, recall, accuracy, etc.). Using the weighted dataset may also lead to increased memory efficiency, for example, because less data will need to be stored for the machine learning models to train.

The computing system 100 may include a training system 102, a client device 104, and/or a database 106. The training system 102 may include a communication subsystem 112, a machine learning (ML) subsystem 114, and/or a weighting subsystem 116. The communication subsystem 112 may retrieve one or more datasets from the database 106. The one or more datasets may be used by the ML subsystem 114 to train one or more machine learning models.

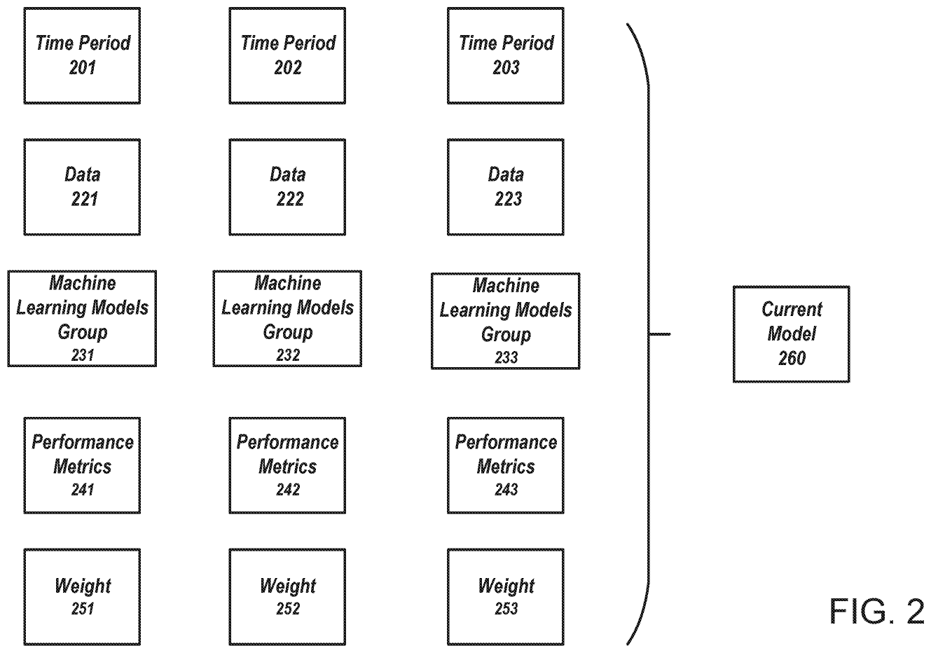

The ML subsystem 114 may train a plurality of machine learning models. Each machine learning model may be trained using a different training dataset. Each training dataset may be unique and/or may have overlapping data. Each machine learning model may correspond to a particular time. Referring to FIG. 2, the ML subsystem 114 may receive data 221 (e.g., from the database 106) corresponding to time period 201 and may use the data 221 to train the machine learning models group 231. The ML subsystem 114 may use all of the data 221 to train each machine learning model of the machine learning models group 231. Alternatively, the ML subsystem 1.14 may use a portion (e.g., different portions) of the data 221 to train each model of the machine learning models group 231. For example, the time period 201 may correspond to the month of January and the machine learning models group 231 may include one machine learning model trained on each day of January. For example, there may be 31 machine learning models in the machine learning models group 231, with one machine learning model corresponding to one day in January. The data 221 may include data that was available to train the machine learning models group 231 during the time period 201. For example, the data 221 may include data received during January as well as data received during the previous three months (e.g., October-December of the previous year). Each machine learning model in the group 231 may be trained on a subset of the data 221. For example, the model trained on January 1 may use data received from October 1 through December 31 to train, the model trained on January 2 may use data received from October 2 through January 1 to train, and so on. The machine learning models group 232 may be trained using data 222. The data 222 may correspond to the time period 202. For example, the time period 202 may correspond to the month of February and the data 222 may include data received from November (of the previous year) through February. The data 223 may correspond to the time period 203 and the machine learning models group 233 may be trained using the data 223. For example, the time period 203 may correspond to the month of March and the data 223 may include data from December (of the previous year) through March.

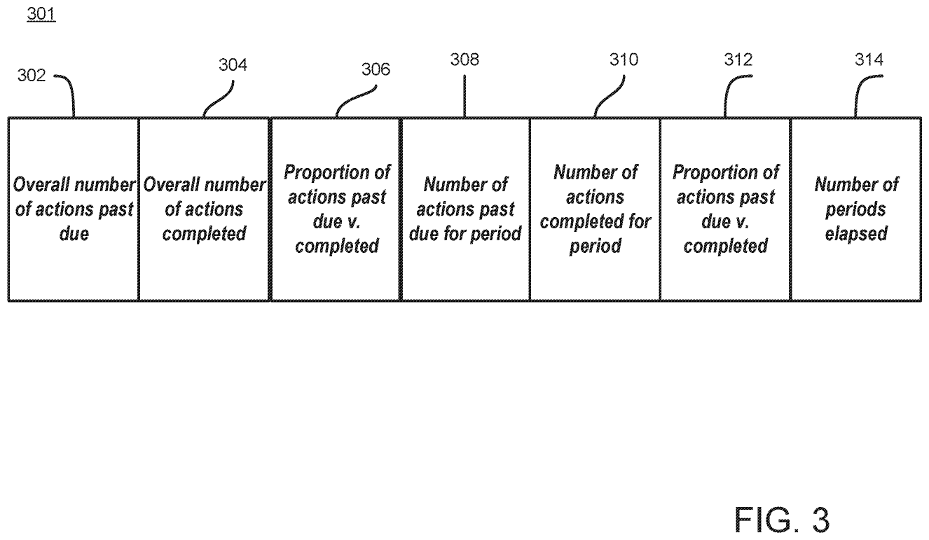

As an example use case for techniques described herein, the computing system may be tasked with using machine learning to predict whether actions will be completed by a deadline (e.g., whether a car dealership will pay an invoice by a deadline). The computing system may train a new machine learning model every day based on new data that is received from one or more previous days. For example, each day, the database 106 may be updated with data indicating actions that have been completed and actions that are still awaiting completion. The update may indicate which actions are past their deadline and which actions are still prior to the deadline. The model may be trained on data corresponding to a predetermined number of time periods preceding the date that the model is trained. For example, the model trained on April 4^{th} may be trained on the previous three months of data received (e.g., data from January 4^{th} through April 4^{th}), the model trained on April 5^{th} may be trained on data from January 5^{th} through April 5^{th}, and so on. Referring to FIG. 3, example features 301 that may be used in training/testing data to predict whether an action will be completed by a deadline are shown. For example, training data and or testing data may include the overall number of actions past due 302, the overall number of actions completed 304, the proportion of actions past due versus completed 306, the number of actions past due for a time period 308, the number of actions completed for a time period 310, the proportion of actions past due versus completed 312, and/or the number of time periods elapsed 314. For example, a time period may include a month, a day, one or more weeks, a quarter of a year, a year, or any other time period. Data discussed in connection with FIG. 2 (e.g., the data 221-223) may include any of the features discussed in connection with FIG. 3. As discussed in more detail below, the training system 102 may determine weights for training data (e.g., training data that includes the example features of FIG. 3, the data 221-223, etc.) to generate a weighted training dataset and/or train a machine learning model to predict whether an action will be completed by a deadline.

Referring back to FIG. 1, the ML subsystem 114 may input a testing dataset into each machine learning model of the plurality of machine learning models. The same testing dataset may be input into each machine learning model. Alternatively, one or more different testing datasets may be input into one or more different machine learning models of the plurality of machine learning models. The ML subsystem 114 may use the testing dataset to determine how well each machine learning model is able to perform in a task (e.g., prediction, classification, content generation, or any other task). The ML subsystem 114 may obtain a plurality of performance metrics using the one or more testing datasets. The plurality of performance metrics may include one or more performance metric for each machine learning model of the plurality of machine learning models. For example, the ML subsystem 114 may use the one or more testing datasets to obtain accuracy, precision, recall, log loss, root mean square error, F1 scores, and/or any other performance metric for each machine learning model. The testing dataset may correspond to a time period that is subsequent to the time periods corresponding to the training datasets used to train the plurality of machine learning models. Referring to FIG. 2. The ML subsystem 114 may use one or more testing datasets to determine performance metrics 241 for each of the machine learning models in group 231. (e.g., in addition to performance metrics 242 for machine learning models in group 232, and/or performance metrics 243 for machine learning models in group 233). For example, if the time periods 201, 202, and 203 correspond to January, February, and March respectively, the ML, subsystem 114 may use a testing dataset corresponding to April, May, and/or some other subsequent time period to obtain performance metrics.

Referring to FIG. 1, the weighting subsystem 116 may select, based on the plurality of performance metrics, a subset of the plurality of machine learning models. By selecting a subset of the plurality of machine learning models, the training system 102 may be able to determine a machine learning model that is representative of each group (and, for example by extension, representative of each training dataset). This may enable the training system 102 to determine how to weight each training dataset (e.g., as discussed in more detail below). Each machine learning model in the subset of machine learning models may correspond to a different group of machine learning models and/or time period. For example, referring to FIG. 2, the performance metrics 241 may include performance metrics for each of the machine learning models in machine learning models group 231, the performance metrics 242 may include performance metrics for each of the machine learning models in machine learning models group 232, and/or the performance metrics 243 may include performance metrics for each of the machine learning models in machine learning models group 233. The weighting subsystem 116 may select a subset of the plurality of machine learning models by selecting one or more machine learning models from group 231, group 232, and/or group 233. The weighting subsystem 116 may select one machine learning model that had the highest performance metric from each of group 231-233. For example, the weighting subsystem 116 may select the machine learning model with the highest accuracy from group 231, the machine learning model with the highest accuracy from group 232, and so on. Additionally or alternatively, the weighting subsystem 116 may select the machine learning model with a median performance metric from each group. For example, the weighting subsystem 116 may select the machine learning model with a median precision score from group 231, the machine learning model with the median precision score from group 232, and the machine learning model with the median precision score from group 233. For example, the weighting subsystem 116 may determine the median precision score from group 231 and select the machine learning model that matches the determined median precision score for the group. Additionally or alternatively, the weighting subsystem 116 may select a machine learning model that is closest to the average performance metric for a group (e.g., for each group 231-233).

Referring to FIG. 1, the weighting subsystem 116 may determine (e.g., based on a comparison of performance metrics corresponding to each machine learning model in the subset of machine learning models), a weight for each machine learning model of the subset of machine learning models. The weight determined for each machine learning model may be used to weight a corresponding dataset. For example, a training dataset that was used to train a machine learning model may be weighted by the weight determined for the machine learning model. Referring to FIG. 2, the weighting subsystem 116 may determine the performance metrics from each of the performance metrics 241-243 that correspond to the subset of machine learning models. Each machine learning model in the subset may be compared based on the performance metric. For example, each machine learning model in the subset may be ranked (e.g., in descending order) based on each machine learning model's corresponding accuracy. Each model may be assigned a weight that is proportional to the model's rank/order. For example, if a machine learning model from group 231 had the highest accuracy as compared to machine learning models selected from groups 232-233), the machine learning model form group 231 may be assigned a weight that is higher than weights assigned to the machine learning models selected from groups 232-233. In some embodiments, the accuracies (e.g., or any other performance metric) for each machine learning model may be normalized (e.g., using the formula

$${x}_{normalized} = \frac{x - {x}_{min}}{{x}_{max} - {x}_{min}} )$$

and the assigned weights may be equal to the accuracy values (e.g., or any other performance metric) after normalization. For example, if the machine learning model from group 231 had an accuracy of 0.9, the machine learning model from group 232 had an accuracy of 0.5, and the machine learning model from group 233 had an accuracy of 0.7, the values may be normalized to 1, 0.5, and 0. In this example, the weight given to the machine learning model from group 231 may be 1, the weight given to the machine learning model from group 232 may be 0.5, and/or the weight given to the machine learning model from group 233 may be 0.

In some embodiments, the weighting subsystem 116 may assign a zero weight to a machine learning model in the subset, for example, if a performance metric associated with the machine learning model is below a threshold value. For example, if the recall score for a machine learning model is below a threshold (e.g., below 0.5, below 0.8, etc.) the weighting subsystem 116 may assign a weight of zero to the machine learning model.

Referring to FIG. 1, the weighting subsystem 116 may generate a weighted dataset by weighting each training dataset used to train each machine learning model (e.g., by the weight determined for a machine learning model corresponding to the dataset). For example, referring to FIG. 2, the weight 251 may correspond to the machine learning model selected from the group 231, the weight 252 may correspond to the machine learning model selected from group 232, and the weight 253 may correspond to the machine learning model selected from group 233. The weight 251 may be used to weight data 221, the weight 252 may be used to weight data 222, and the weight 253 may be used to weight data 223 because that is the data that was used to train the corresponding machine learning models). For example, each feature in a training dataset may be weighted according to the weight corresponding to the training dataset. As an additional example, one or more entries (e.g., each entry) in the training dataset may be weighted based on the corresponding weight.

The ML subsystem 114 may train a machine learning model using the weighted dataset. For example, the ML subsystem 114 may train a new machine learning model using the weighted dataset. Alternatively, the ML subsystem 114 may train an existing machine learning model (e.g., by updating the weights, via transfer learning, etc.) with the weighted dataset. Referring to FIG. 2, the current model 260 may be trained using data 221 after the features of data 221 are weighted by weight 251), data 222 (e.g., after the features of data 222 are weighted by weight 252), and/or data 223 (e.g., after the features of data 223 are weighted by weight 253). The weighted data 221-223 may be aggregated to form a weighted dataset for training a new or existing machine learning model.

The client device 104 may be any computing device, including, but not limited to, a laptop computer, a tablet computer, a hand-held computer, smartphone, other computer equipment (e.g., a server or virtual server), including “smart,” wireless, wearable, Internet of Things device, and/or mobile devices. The client device 104 may send commands to the training system 102 (e.g., to generate a weighted dataset, to train a machine learning model, etc.). Although only one client device 104 is shown, the system 100 may include any number of client devices.

The training system 102 may include one or more computing devices described above and/or may include any type of mobile terminal, fixed terminal, or other device. For example, the training system 102 may be implemented as a cloud computing system and may feature one or more component devices. A person skilled in the art would understand that system 100 is not limited to the devices shown in FIG. 1. Users may, for example, utilize one or more other devices to interact with devices, one or more servers, or other components of system 100. A person skilled in the art would also understand that while one or more operations are described herein as being performed by particular components of the system 100, those operations may, in some embodiments, be performed by other components of the system 100. As an example, while one or snore operations are described herein as being performed by components of the training system 102, those operations may be performed by components of the client device 104, and/or database 106. In some embodiments, the various computers and systems described herein may include one or more computing devices that are programmed to perform the described functions. Additionally or alternatively, multiple users may interact with system 100 and/or one or more components of system 100. For example, a first user and a second user may interact with the training system 102 using two different client devices.

One or more components of the training system 102, client device 104, and/or database 106, may receive content and/or data via input/output (hereinafter “I/O”) paths. The one or more components of the training system 102, the client device 104, and/or the database 106 may include processors and/or control circuitry to send and receive commands, requests, and other suitable data using the I/O paths. The control circuitry may include any suitable processing, storage, and/or input/output circuitry. Each of these devices may include a user input interface and/or user output interface (e.g., a display) for use in receiving and displaying data. It should be noted that in some embodiments, the training system 102, the client device 104, and/or the database 106 may have neither user input interface nor displays and may instead receive and display content using another device (e.g., a dedicated display device such as a computer screen and/or a dedicated input device such as a remote control, mouse, voice input, etc.). Additionally, the devices in system 100 may run an application (or another suitable program). The application may cause the processors and/or control circuitry to perform operations related to weighting training data (e.g., to increase the efficiency of training and/or performance of one or more machine learning models).

One or more components and/or devices in the system 100 may include electronic storages. The electronic storages may include non-transitory storage media that electronically stores information. The electronic storage media of the electronic storages may include one or both of (a) system storage that is provided integrally (e.g., substantially non-removable) with servers or client devices or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or snore virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 1 also includes a network 150. The network 150 may be the Internet, a mobile phone network, a mobile voice or data network (e.g., a 5G or LTE network), a cable network, a public switched telephone network, a combination of these networks, or other types of communications networks or combinations of communications networks. The devices in FIG. 1 (e.g., training system 102, the client device 104, and/or the database 106) may communicate (e.g., with each other or other computing systems not shown in FIG. 1) via the network 150 using one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The devices in FIG. 1 may include additional communication paths linking hardware, software, and/or firmware components operating together. For example, the training system 102, any component of the training system (e.g., the communication subsystem 112, the ML subsystem 114, and/or the weighting subsystem 116), the client device 104, and/or the database 106 may be implemented by one or more computing platforms.

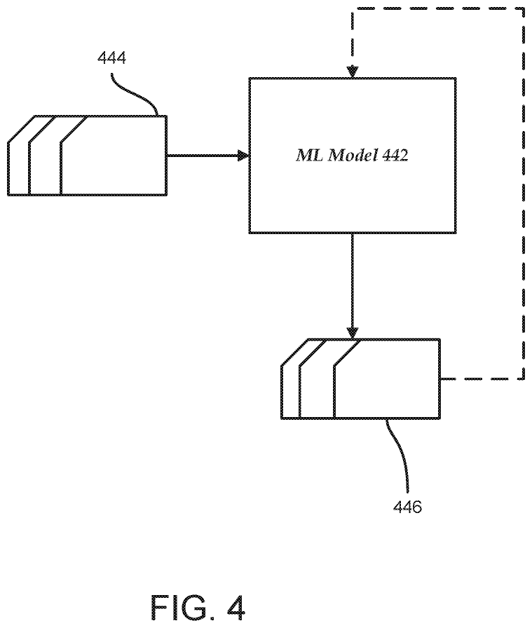

One or more machine learning models discussed above may be implemented (e.g., in part), for example, as shown in FIG. 4. With respect to FIG. 4, machine learning model 442 may take inputs 444 and provide outputs 446. In one use case, outputs 446 may be fed back to machine learning model 442 as input to train machine learning model 442 (e.g., alone or in conjunction with user indications of the accuracy of outputs 446, labels associated with the inputs, or with other reference feedback and/or performance metric information). In another use case, machine learning model 442 may update its configurations (e.g., weights, biases, or other parameters) based on its assessment of its prediction (e.g., outputs 446) and reference feedback information (e.g., user indication of accuracy, reference labels, or other information). In another example use case, where machine learning model 442 is a neural network and connection weights may be adjusted to reconcile differences between the neural network's prediction and the reference feedback. In a further use case, one or more neurons (or nodes) of the neural network may require that their respective errors are sent backward through the neural network to them to facilitate the update process (e.g., backpropagation of error). Updates to the connection weights may, for example, be reflective of the magnitude of error propagated backward after a forward pass has been completed. In this way, for example, the machine learning model 442 may be trained to generate results (e.g., response time predictions, sentiment identifiers, urgency levels, etc.) with better recall, accuracy, and/or precision.

In some embodiments, the machine learning model 442 may include an artificial neural network. In such embodiments, machine learning model 442 may include an input layer and one or more hidden layers. Each neural unit of the machine learning model may be connected with one or more other neural units of the machine learning model 442. Such connections can be enforcing or inhibitory in their effect on the activation state of connected neural units. Each individual neural unit may have a summation function which combines the values of one or more of its inputs together. Each connection (or the neural unit itself) may have a threshold function that a signal must surpass before it propagates to other neural units. The machine learning model 442 may be self-learning and/or trained, rather than explicitly programmed, and may perform significantly better in certain areas of problem solving, as compared to computer programs that do not use machine learning. During training, an output layer of the machine learning model 442 may correspond to a classification, and an input known to correspond to that classification may be input into an input layer of machine learning model during training. During testing, an input without a known classification may be input into the input layer, and a determined classification may be output. For example, the classification may be an indication of whether an action is predicted to be completed by a corresponding deadline or not. The machine learning model 442 trained by the ML subsystem 114 may include one or more embedding layers at which information or data (e.g., any data or information discussed above in connection with FIGS. 1-4A) is converted into one or more vector representations. The one or more vector representations of the message may be pooled at one or more subsequent layers to convert the one or more vector representations into a single vector representation.

The machine learning model 442 may be structured as a factorization machine model. The machine learning model 442 may be a non-linear model and/or supervised learning model that can perform classification and/or regression. For example, the machine learning model 442 may be a general-purpose supervised learning algorithm that the system uses for both classification and regression tasks. Alternatively, the machine learning model 442 may include a Bayesian model configured to perform variational inference, for example, to predict whether an action will be completed by the deadline. The machine learning model 442 may be implemented as a decision tree and/or as an ensemble model (e.g., using random forest, bagging, adaptive booster, gradient boost, XGBoost, etc.).

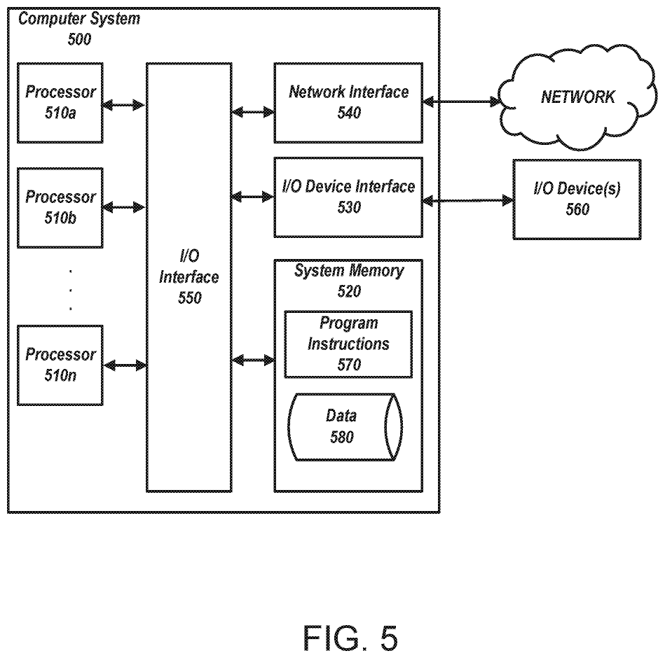

FIG. 5 is a diagram that illustrates an exemplary computing system 500 in accordance with embodiments of the present technique. Various portions of systems and methods described herein, may include or be executed on one or more computer systems similar to computing system 500. Further, processes and modules described herein may be executed by one or more processing systems similar to that of computing system 500.

Computing system 500 may include one or more processors (e.g., processors 510a-510n) coupled to system memory 520, an input/output I/O device interface 530, and a network interface 540 via an input/output (I/O) interface 550. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 500. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 520). Computing system 500 may be a units-processor system including one processor (e.g., processor 510a), or a multi-processor system including any number of suitable processors (e.g., 510a-510n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing system 500 may include a plurality of computing devices (e.g., distributed computer systems) to implement various processing functions.

I/O device interface 530 may provide an interface for connection of one or more I/O devices 560 to computing system 500. I/O devices may include devices that receive input (e.g., from a user) or output information (e.g., to a user). I/O devices 560 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 560 may be connected to computing system 500 through a wired or wireless connection. I/O devices 560 may be connected to computing system 500 from a remote location. I/O devices 560 located on remote computer system, for example, may be connected to computing system 500 via a network and network interface 540.

Network interface 540 may include a network adapter that provides for connection of computing system 500 to a network. Network interface may 540 may facilitate data exchange between computing system 500 and other devices connected to the network. Network interface 540 may support wired or wireless communication. The network may include an electronic communication network, such as the Internet, a local area network (LAN), a wide area network (WAN), a cellular communications network, or the like.

System memory 520 may be configured to store program instructions 570 or data 580. Program instructions 570 may be executable by a processor (e.g., one or more of processors 510a-510n) to implement one or more embodiments of the present techniques. Instructions 570 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 520 may include a tangible program carrier having program instructions stored thereon. A tangible program carrier may include a non-transitory computer readable storage medium. A non-transitory computer readable storage medium may include a machine readable storage device, a machine readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 520 may include a non-transitory computer readable storage medium that may have program instructions stored thereon that are executable by a computer processor (e.g., one or more of processors 510a-510n) to cause the subject matter and the functional operations described herein. A memory (e.g., system memory 520) may include a single memory device and/or a plurality of memory devices (e.g., distributed memory devices).

I/O interface 550 may be configured to coordinate I/O traffic between processors 510a-510n, system memory 520, network interface 540, I/O devices 560, and/or other peripheral devices. I/O interface 550 may perform protocol, timing, or other data transformations to convert data signals from one component (e.g., system memory 520) into a format suitable for use by another component (e.g., processors 510a-510n). I/O interface 550 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computing system 500 or multiple computer systems 500 configured to host different portions or instances of embodiments. Multiple computer systems 500 may provide for parallel or sequential processing/execution of one or more portions of the techniques described herein.

Those skilled in the art will appreciate that computing system 500 is merely illustrative and is not intended to limit the scope of the techniques described herein. Computing system 500 may include any combination of devices or software that may perform or otherwise provide for the performance of the techniques described herein. For example, computing system 500 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computing system 500 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available,

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computing system 500 may be transmitted to computing system 500 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present disclosure may be practiced with other computer system configurations.

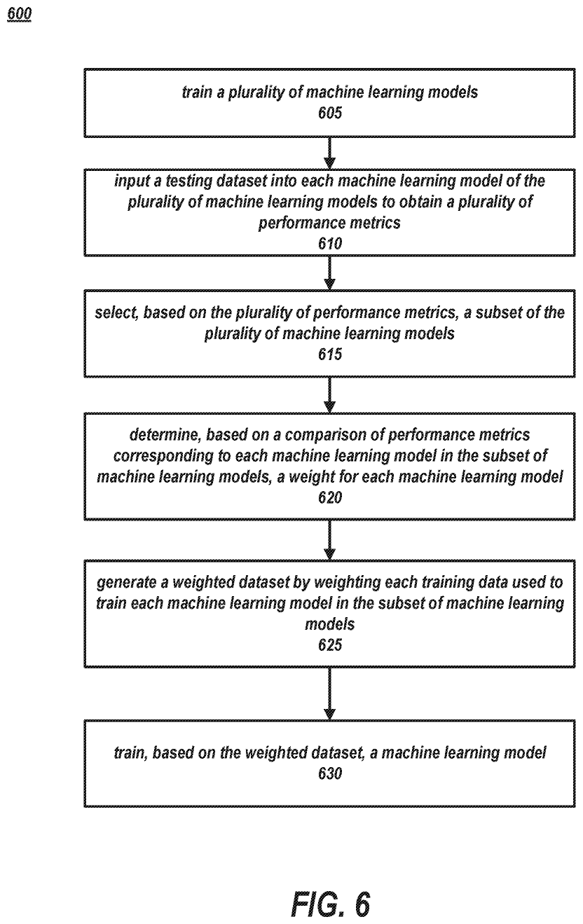

FIG. 6 shows an example flowchart of the actions involved in weighting training data for machine learning models. For example, process 600 may represent the actions taken by one or more devices shown in FIGS. 1-5 and described above. At 605, training system 102 (e.g., using one or more components in system 100 (FIG. 1) and/or computing system 500 via I/O interface 550 and/or processors 510a-510n (FIG. 5)) trains a plurality of machine learning models. The plurality of machine learning models may include one or more decision trees, neural networks, Bayesian models, or any other model as described above in connection with FIG. 4. The plurality of machine learning models may be trained, for example, as described above in connection with FIG. 4. Each machine learning model may be trained using a different training dataset from a plurality of training datasets. For example, each training dataset may correspond to a different time period.

At 610, training system 102 (e.g., using one or more components in system 100 (FIG. 1) and/or computing system 500 via one or more processors 510a-510n and system memory 520 (FIG. 5)) inputs a testing dataset into each machine learning model (e.g., as described above in connection with FIG. 4) to obtain a plurality of performance metrics corresponding to each machine learning model. The testing dataset may correspond to a time period that is subsequent to the time periods of the data that was used to train each machine learning model. One or more performance metrics for each machine learning model may be obtained. For example, accuracy, log loss, precision, recall, specificity, F1 score, root mean squared error, or any other performance metric may be obtained. In some embodiments, speed (e.g., how long a machine learning model takes to generate a prediction) may be used as a performance metric.

At 615, training system 102 (e.g., using one or more components in system 100 (FIG. 1) and/or computing system 500 via one or more processors 510a-510n, I/O interface 550, and/or system memory 520 (FIG. 5)) selects, based on the plurality of performance metrics, a subset of the plurality of machine learning models. Each selected machine learning model may correspond to a different time period. For example, a first machine learning model in the subset may correspond to a group of machine learning models that were trained using data from a first time period and a second machine learning model in the subset may correspond to a group of machine learning models that were trained using data from a second time period.

At 620, training system 102 (e.g., using one or more components in system 100 (FIG. 1) and/or computing system 500 via one or more processors 510a-510n (FIG. 5)) determines, based on a comparison of performance metrics corresponding to each machine learning model in the subset of machine learning models, a weight for each machine learning model (e.g., a weight for each machine learning model of the subset of machine learning models selected in step 615).

At 625, training system 102 (e.g., using one or more components in system 100 (FIG. 1) and/or computing system 500 (FIG. 5)) generates a weighted dataset by weighting each training dataset used to train each machine learning model in the subset of machine learning models. For example, each training dataset may be weighted according to the weight determined for each corresponding machine learning model.

At 630, training system 102 using one or more components in system 100 (FIG. 1) and/or computing system 500 via the network interface 540 (FIG. 5)) trains, based on the weighted dataset, a machine learning model. The machine learning model may be a new machine learning model. Alternatively, the machine learning model may be an existing machine learning model that is given additional training using the weighted dataset.

It is contemplated that the actions or descriptions of FIG. 6 may be used with any other embodiment of this disclosure. In addition, the actions and descriptions described in relation to FIG. 6 may be done in alternative orders or in parallel to further the purposes of this disclosure. For example, each of these actions may be performed in any order, in parallel, or simultaneously to reduce lag or increase the speed of the system or method. Furthermore, it should be noted that any of the devices or equipment discussed in relation to FIGS. 1-5 could be used to perform one or more of the actions in FIG. 6.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g., within a data center or geographically), or otherwise differently organized. The functionality described herein may be provided by one or more processors of one or more computers executing code stored on a tangible, non-transitory, machine readable medium. In some cases, third party content delivery networks may host some or all of the information conveyed over networks, in which case, to the extent information (e.g., content) is said to be supplied or otherwise provided, the information may be provided by sending instructions to retrieve that information from a content delivery network.

The reader should appreciate that the present application describes several disclosures. Rather than separating those disclosures into multiple isolated patent applications, applicants have grouped these disclosures into a single document because their related subject matter ends itself to economies in the application process. But the distinct advantages and aspects of such disclosures should not be conflated. In some cases, embodiments address all of the deficiencies noted herein, but it should be understood that the disclosures are independently useful, and some embodiments address only a subset of such problems or offer other, unmentioned benefits that will be apparent to those of skill in the art reviewing the present disclosure. Due to costs constraints, some features disclosed herein may not be presently claimed and may be claimed in later filings, such as continuation applications or by amending the present claims. Similarly, due to space constraints, neither the Abstract nor the Summary sections of the present document should be taken as containing a comprehensive listing of all such disclosures or all aspects of such disclosures.

It should be understood that the description and the drawings are not intended to limit the disclosure to the particular form disclosed, but to the contrary, the intention is to cover all modifications, equivalents, and alternatives falling within the spirit and scope of the present disclosure as defined by the appended claims. Further modifications and alternative embodiments of various aspects of the disclosure will be apparent to those skilled in the art in view of this description. Accordingly, this description and the drawings are to be construed as illustrative only and are for the purpose of teaching those skilled in the art the general manner of carrying out the disclosure. It is to be understood that the forms of the disclosure shown and described herein are to be taken as examples of embodiments. Elements and materials may be substituted for those illustrated and described herein, parts and processes may be reversed or omitted, and certain features of the disclosure may be utilized independently, all as would be apparent to one skilled in the art after having the benefit of this description of the disclosure. Changes may be made in the elements described herein without departing from the spirit and scope of the disclosure as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The, term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing actions A, B, C, and D) encompasses both all such attributes or functions being mapped to all such objects and subsets of the attributes or functions being mapped to subsets of the attributes or functions (e.g., both all processors each performing actions A-D, and a case in which processor 1 performs action A, processor 2 performs action B and part of action C, and processor 3 performs part of action C and action D), unless otherwise indicated. Further, unless otherwise indicated, statements that one value or action is “based on” another condition or value encompass both instances in which the condition or value is the sole factor and instances in which the condition or value is one factor among a plurality of factors. The term “each” is not limited to “each and every” unless indicated otherwise. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device.

The above-described embodiments of the present disclosure are presented for purposes of illustration and not of limitation, and the present disclosure is limited only by the claims which follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:

1. A method comprising: training a plurality of machine learning models; inputting a dataset into each model of the plurality of machine learning models to obtain a plurality of performance metrics; selecting a subset of the plurality of machine learning models; determining a weight for each machine learning model of the subset of machine learning models; generating a weighted dataset; and training, based on the weighted dataset, a new machine learning model.
2. The method of any of the preceding embodiments, wherein selecting a subset of the plurality of machine learning models comprises: grouping each machine learning model of the plurality of machine learning models into a plurality of groups based on a time periods corresponding to training data of each machine learning model; and selecting, based on comparing the plurality of performance metrics, a machine learning model from each group of the plurality of groups to add to the subset of the plurality of machine learning models.
3. The method of any of the preceding embodiments, wherein the selecting a machine learning model from each group of a plurality of groups comprises selecting a machine learning model associated with a highest performance metric from each group of a plurality of groups of machine learning models.
4. The method of any of the preceding embodiments, wherein selecting a machine learning model from each group of a plurality of groups of machine learning models comprises selecting a machine learning model associated with a median performance metric from each group of plurality of groups.
5. The method of any of the preceding embodiments, wherein the dataset corresponds to a time period that is later than different time periods corresponding to the training datasets used to train the plurality of machine learning models.
6. The method of any of the preceding embodiments, wherein determining a weight for each machine learning model further comprises: comparing a first performance metric of the plurality of performance metrics with a second performance metric of the plurality of performance metrics; and based on a determination that the first performance metric is greater than the second performance metric, assigning a first weight to a first machine learning model that corresponds to the first performance metric and a second weight to a second machine learning model that corresponds to the second performance metric, wherein the first weight is greater than the second weight.
7. The method of any of the preceding embodiments, wherein weighting each dataset of the plurality of datasets comprises: determining a first performance metric of the plurality of performance metrics that fails to satisfy a threshold; and in response to determining that the first performance metric fails to satisfy the threshold, assigning zero weight to a machine learning model of the subset of machine learning models that corresponds to the first performance metric.
8. The method of any of the preceding embodiments, wherein the plurality of performance metrics comprises one or more of accuracy, precision, and recall.
9. A tangible, non-transitory, machine-readable medium storing instructions that, when executed by a data processing apparatus, cause the data processing apparatus to perform operations comprising those of any of embodiments 1-8.
10. A system comprising: one or more processors; and memory storing instructions that, when executed by the processors, cause the processors to effectuate operations comprising those of any of embodiments 1-8.
11. A system comprising means for performing any of embodiments 1-8.

What is claimed is:

1. A system for weighting training data to increase performance of a machine learning model, the system comprising:
one or more processors and computer program instructions that, when executed, cause the one or more processors to perform operations comprising:
training a plurality of machine learning models, wherein each machine learning model is trained using a different training dataset from a plurality of training datasets, wherein each training dataset corresponds to a different time period;
inputting a testing dataset into each machine learning model of the plurality of machine learning models to obtain a plurality of performance metrics comprising a performance metric for each machine learning model of the plurality of machine learning models, wherein the testing dataset corresponds to a time period that is subsequent to the different time periods corresponding to the training datasets, and wherein each performance metric corresponds to an accuracy level of each machine learning model;
selecting, based on the plurality of performance metrics, a subset of the plurality of machine learning models, wherein each machine learning model in the subset corresponds to a different time period;
determining, based on a comparison of performance metrics corresponding to each machine learning model in the subset of machine learning models, a weight for each machine learning model of the subset of machine learning models;
generating a weighted dataset by weighting each training dataset used to train each machine learning model in the subset of machine learning models by the corresponding determined weight; and
training, based on the weighted dataset, a new machine learning model.

2. The system of claim 1, wherein the instructions for selecting a subset of the plurality of machine learning models, when executed, cause operations further comprising:
grouping each machine learning model of the plurality of machine learning models into a plurality of groups based on time periods corresponding to training data of each machine learning model; and
selecting, based on comparing the plurality of performance metrics, a machine learning model from each group of the plurality of groups to add to the subset of the plurality of machine learning models.

3. The system of claim 1, wherein the instructions for determining a weight for each machine learning model, when executed, cause operations further comprising:
comparing a first performance metric of the plurality of performance metrics with a second performance metric of the plurality of metrics; and
based on a determination that the first performance metric is greater than the second performance metric, assigning a first weight to a first machine learning model that corresponds to the first performance metric and a second weight to a second machine learning model that corresponds to the second performance metric, wherein the first weight is greater than the second weight.

4. The system of claim 1, wherein the instructions for weighting each dataset of the plurality of datasets comprises:
determining a first performance metric of the plurality of performance metrics that fails to satisfy a threshold; and
in response to determining that the first performance metric fails to satisfy the threshold, assigning zero weight to a machine learning model of the subset of machine learning models that corresponds to the first performance metric.

5. A method comprising:
training a plurality of machine learning models using a plurality of datasets, wherein each dataset of the plurality of datasets corresponds to a different time period;
inputting a new dataset into each model of the plurality of machine learning models to obtain a plurality of performance metrics comprising a performance metric for each machine learning model of the plurality of machine learning models;
selecting, based on the plurality of performance metrics, a subset of the plurality of machine learning models;
determining, based on a comparison of performance metrics corresponding to machine learning models in the subset of machine learning models, a weight for each machine learning model of the subset of machine learning models;
generating a weighted dataset by weighting each training data used to train each machine learning model in the subset of machine learning models by the corresponding determined weight; and
training, based on the weighted dataset, a new machine learning model.

6. The method of claim 5, wherein selecting a subset of the plurality of machine learning models comprises:
grouping each machine learning model of the plurality of machine learning models into a plurality of groups based on a time periods corresponding to training data of each machine learning model; and
selecting, based on comparing the plurality of performance metrics, a machine learning model from each group of the plurality of groups to add to the subset of the plurality of machine learning models.

7. The method of claim 6, wherein the selecting a machine learning model from each group of the plurality of groups comprises selecting a machine learning model associated with a highest performance metric from each group of the plurality of groups.

8. The method of claim 6, wherein selecting a machine learning model from each group of the plurality of groups comprises selecting a machine learning model associated with a median performance metric from each group of the plurality of groups.

9. The method of claim 5, wherein the new dataset corresponds to a time period that is later than the different time periods corresponding to the training datasets.

10. The method of claim , wherein determining a weight for each machine learning model further comprises:
comparing a first performance metric of the plurality of performance metrics with a second performance metric of the plurality of performance metrics; and
based on a determination that the first performance metric is greater than the second performance metric, assigning a first weight to a first machine learning model that corresponds to the first performance metric and a second weight to a second machine learning model that corresponds to the second performance metric, wherein the first weight is greater than the second weight.

11. The method of claim 5, wherein weighting each dataset of the plurality of datasets comprises:
determining a first performance metric of the plurality of performance metrics that fails to satisfy a threshold; and
in response to determining that the first performance metric fails to satisfy the threshold, assigning zero weight to a machine learning model of the subset of machine learning models that corresponds to the first performance metric.

12. The method of claim 5, wherein the plurality of performance metrics comprises one or more of accuracy, precision, and recall.

13. A tangible, non-transitory, machine-readable medium storing instructions that when executed by one or more processors effectuate operations comprising:
training a plurality of machine learning models using a plurality of datasets, wherein each dataset of the plurality of datasets corresponds to a different time period;
inputting a new dataset into each model of the plurality of machine learning models to obtain a plurality of performance metrics comprising a performance metric for each machine learning model of the plurality of machine learning models;
selecting, based on the plurality of performance metrics, a subset of the plurality of machine learning models;
determining, based on a comparison of performance metrics corresponding to machine learning models in the subset of machine learning models, a weight for each machine learning model of the subset of machine learning models;
generating a weighted dataset by weighting each training data used to train each machine learning model in the subset of machine learning models by the corresponding determined weight; and
training, based on the weighted dataset, a new machine learning model.

14. The medium of claim 13, wherein the instructions for selecting a subset of the plurality of machine learning models, when executed, effectuate operations further comprising:
grouping each machine learning model of the plurality of machine learning models into a plurality of groups based on a time periods corresponding to training data of each machine learning model; and
selecting, based on comparing the plurality of performance metrics, a machine learning model from each group of the plurality of groups to add to the subset of the plurality of machine learning models.

15. The medium of claim 14, wherein the instructions for selecting a machine learning model from each group of the plurality of groups, when executed, effectuate operations further comprising selecting a machine learning model associated with a highest performance metric from each group of the plurality of groups.

16. The medium of claim 14, wherein the instructions for selecting a machine learning model from each group of the plurality of groups, when executed, effectuate operations further comprising selecting a machine learning model associated with a median performance metric from each group of the plurality of groups.

17. The medium of claim 13, wherein the new dataset corresponds to a time period that is later than the different time periods corresponding to the training datasets.

18. The medium of claim 13, wherein the instructions for determining a weight for each machine learning model, when executed, effectuate operations further comprising:
comparing a first performance metric of the plurality of performance metrics with a second performance metric of the plurality of performance metrics; and
based on a determination that the first performance metric is greater than the second performance metric, assigning a first weight to a first machine learning model that corresponds to the first performance metric and a second weight to a second machine learning model that corresponds to the second performance metric, wherein the first weight is greater than the second weight.

19. The medium of claim 13, wherein the instructions for weighting each dataset of the plurality of datasets, when executed, effectuate operations further comprising:
determining a first performance metric of the plurality of performance metrics that fails to satisfy a threshold; and
in response to determining that the first performance metric fails to satisfy the threshold, assigning zero weight to a machine learning model of the subset of machine learning models that corresponds to the first performance metric.

20. The medium of claim 13, wherein the plurality of performance metrics comprises one or more of accuracy, precision, and recall.
